(19) United States
(12) Patent Application Publication
(10) Pub. No.: US 2011/0207070 A1
(43) Pub. Date: Aug. 25, 2011

(54) Orthodontic System

(75) Inventors: Nei-Chang Yu, Taipei (TW); Nai-Wen Yu, Taipei (TW)

(73) Assignee: Nei-Chang Yu, Taipei (TW)

(21) Appl. No.: 12/466,205

(22) Filed: May 14, 2009

(30) Foreign Application Priority Data
Jul. 10, 2008 (TW) 097212214

(51) Int. Cl. A61C 7/02; A61C 7/00

(52) U.S. Cl. 433/3; 433/18

(57) ABSTRACT

An orthodontic system includes a tap, a screw and a tool. A user can maneuver the tool to drive the tap and screw. The tap is used to make a hole in an alveolus bone. The screw is used for firm insertion in the alveolus bone through the hole made with the tap.

### FIELD OF INVENTION

The present invention relates to an orthodontic system and, more particularly, to an orthodontic system including a tap and a screw including a rectangular aperture defined therein for receiving a rectangular second wire.

### BACKGROUND OF INVENTION

Referring to FIG. 11, a conventional orthodontic screw 7 includes a threaded body 71, a platform 72 on the threaded body 71, a head 73 and a neck 74 between the platform 72 and the head 73. The diameter of the neck 74 is smaller than the diameters of the platform 72 and the head 73. The orthodontic screw 7 is preferably made of a titanic alloy for good biologic compatibility. The orthodontic screw 7 made of a titanic alloy is however soft.

In a standard process, a slit is made in the gingival tissue with a knife, and a portion of the gingival tissue is flipped over. A hole is made in the alveolus bone with an electric dental engine. With the dental engine, the threaded body 71 is driven in the alveolus bone through the hole while the platform 72, the neck 74 and the head 73 are located outside the alveolus bone. An orthodontic wire and a spring are used to pull a tooth towards the orthodontic screw 7. The depth in the alveolus bone reached with the threaded body 71 is critical. If the depth is too small, the threaded body 71 will be too weak to pull the tooth via the orthodontic wire and the spring. If the depth is too big, the threaded body 71 might be driven into the alveolus bone from one side and extended from the alveolus bone from another side because of the high speed of the electric dental engine.

In a shortened process, the step of making a slit in the gingival tissue and the step of flipping over a portion of the gingival tissue of the standard process are sometimes omitted. That is, a hole is made in the gingival tissue and the alveolus bone with the threaded body 71 driven with an electric dental engine. There is one more risk of the necrosis of a portion of the gingival tissue because it might be shredded with the orthodontic screw 7 driven with the electric dental engine operated at high speed. There is another risk of breaching the threaded body 71.

In both of the standard and shortened processes, the stress exerted on the tooth with the orthodontic wire and the spring supported on the orthodontic screw is inadequate. In specific, a torque cannot be exerted on the tooth with the orthodontic screw 7 alone.

The present invention is therefore intended to obviate or at least alleviate the problems encountered in prior art.

### SUMMARY OF INVENTION

It is the primary objective of the present invention to provide a safe, effective orthodontic system.

To achieve the foregoing objective, the orthodontic system includes a tap, a screw and a tool. A user can maneuver the tool to drive the tap and screw. The tap is used to make a hole in an alveolus bone. The screw is used for firm insertion in the alveolus bone through the hole made with the tap.

Other objectives, advantages and features of the present invention will be apparent from the following description referring to the attached drawings.

### BRIEF DESCRIPTION OF DRAWINGS

The present invention will be described via the detailed illustration of three embodiments referring to the drawings.

FIG. 1 is a front view of an orthodontic system according to the first embodiment of the present invention.

FIG. 2 is a front view of a tap of the orthodontic system of FIG. 1.

FIG. 3 is a front view of a screw of the orthodontic system shown in FIG. 1.

FIG. 4 is a partial, perspective view of the screw shown in FIG. 3.

FIG. 5 is a partial, perspective view of a screw according to the second embodiment of the present invention.

FIG. 6 is a partial, perspective view of a screw according to the third embodiment of the present invention.

FIG. 7 is a front view of a spring tied to the screw shown in FIG. 4.

FIG. 8 shows a patient's teeth subjected to orthodontia with the spring and screw shown in FIG. 7.

FIG. 9 is shows a patient's teeth subjected to orthodontia with a first wire and the screw shown in FIG. 5.

FIG. 10 is a perspective view of a first wire and a second wire connected to the screw shown in FIG. 5.

FIG. 11 is a front view of a conventional orthodontic screw.

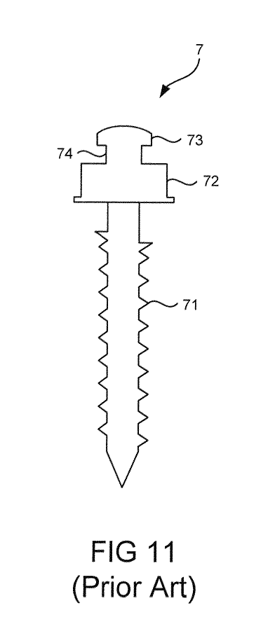

### DETAILED DESCRIPTION OF EMBODIMENTS

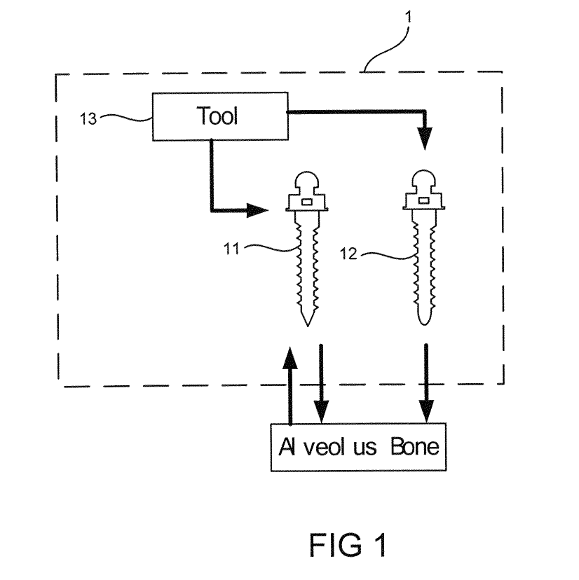

Referring to FIG. 1, an orthodontic system 1 includes a tap 11, a screw 12 and a tool 13 according to a first embodiment of the present invention. The orthodontic system 1 is used for the orthodontia of a patient's teeth. The tool 13 may be a screwdriver or wrench.

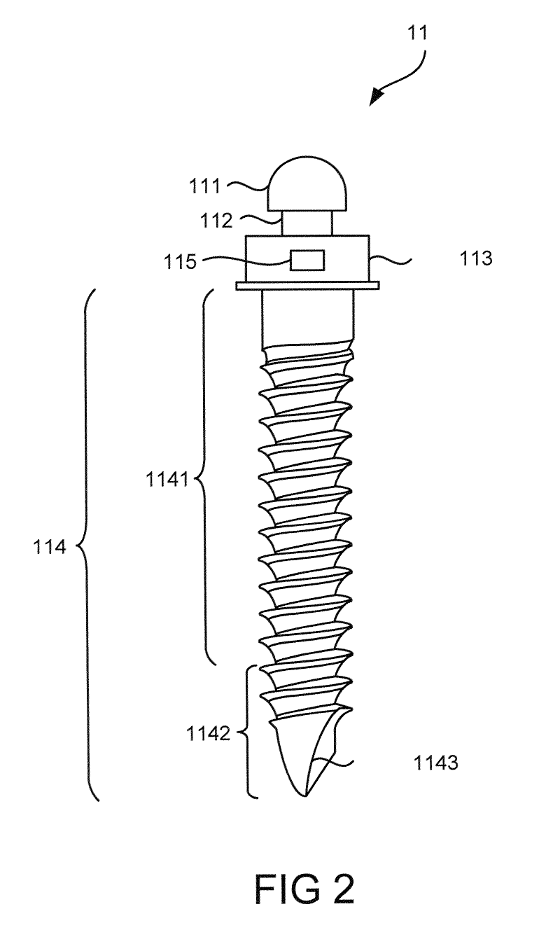

Referring to FIG. 2, the tap 11 includes a body 114, a platform 113 on the threaded body 114, a head 111 and a neck 112 between the platform 113 and the head 111. The diameter of the neck 112 is smaller than the diameters of the platform 113 and the head 111. The neck 112 is made by making a groove around the tap 11. A rectangular aperture 115 is transversely defined in the platform 113. The body 114 includes a thread 1141 formed thereon and a blade 1143 formed at the tip thereof. The tap 11 is preferably made of stainless steel, which is hard. However, the tap 11 may be made of a titanic alloy instead of the stainless steel.

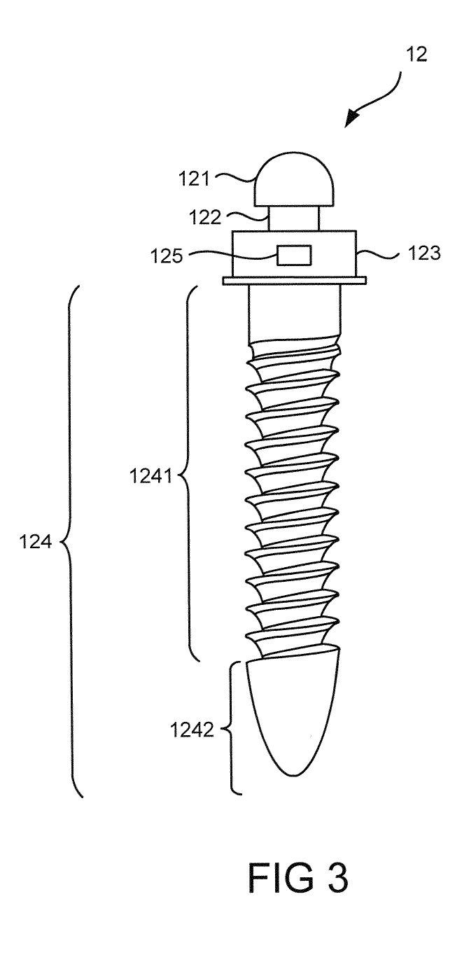

Referring to FIG. 3, the screw 12 includes a body 124, a platform 123 on the threaded body 124, a head 121 and a neck 122 between the platform 123 and the head 121. The diameter of the neck 122 is smaller than the diameters of the platform 123 and the head 121. The neck 122 is made by making a groove around the screw 12. A rectangular aperture 125 is transversely defined in the platform 123. The body 124 includes a thread 1241 formed thereon and a rounded tip 1242 thereof. The screw 12 is preferably made of stainless steel, which is biologically compatible.

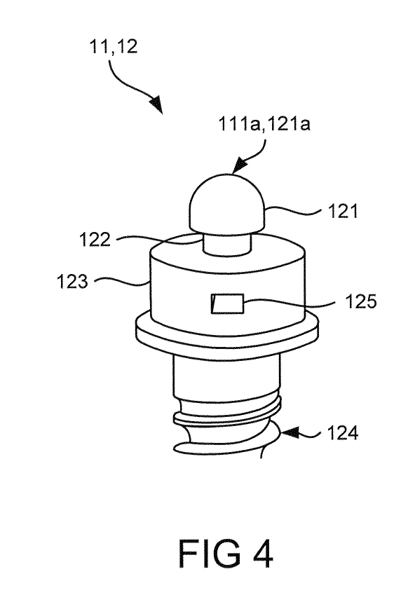

Referring to FIG. 4, the head 111 of the tap 11 includes a dome 111a on the top while the head 121 of the screw 12 includes a dome 121a on the top according to the first embodiment of the present invention.

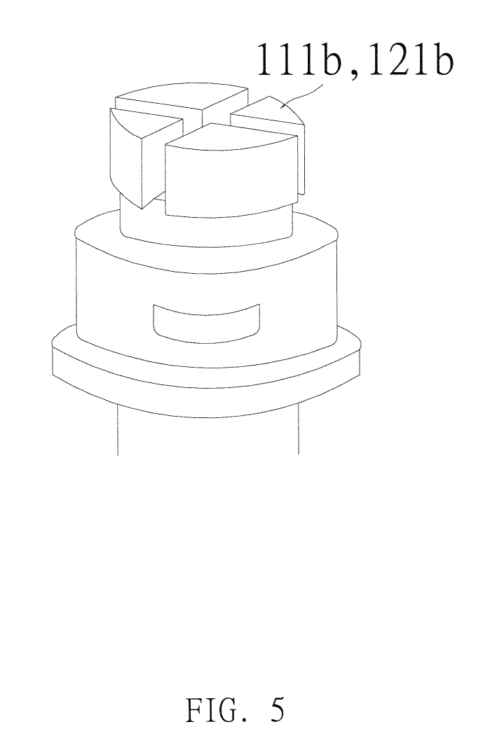

Referring to FIG. 5, the head 111 of the tap 11 is a circular disc and so is the head 121 of the screw 12 according to a second embodiment of the present invention. Radial slits are defined in the head 111, thus dividing the head 111 into blocks 111b. Radial slits are defined in the head 121 of the screw 12, thus dividing the head 121 into blocks 121b. The second embodiment is otherwise identical to the first embodiment.

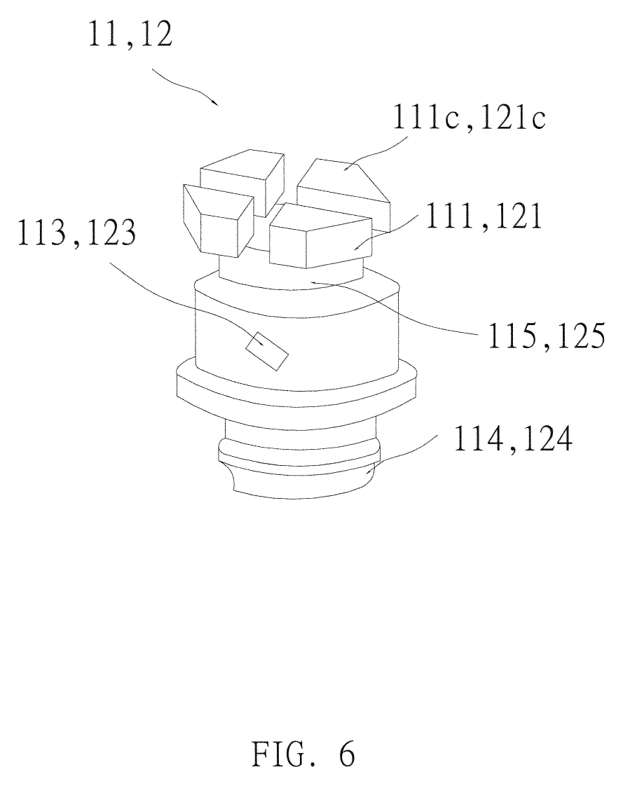

Referring to FIG. 6, the head 111 of the tap 11 is a hexagonal disc and so is the head 121 of the screw 12 according to a third embodiment of the present invention. Radial slits are defined in the head 111, thus dividing the head 111 into blocks 111c. Radial slits are defined in the head 121, thus dividing the head 121 into blocks 121c. The rectangular apertures 113 and 123 are oriented in a different direction in the third embodiment than in the first embodiment. The third embodiment is otherwise identical to the second embodiment.

In an orthodontic operation, a dentist can use the tool 13 to drive the tap 11 by the head 111, 111b or 111c, thus making a hole in the alveolus bone with the blade 1143 and thread 1141 of the body 111 of the tap 11. While trying to penetrate a first wall of the alveolus bone, the dentist encounters resistance. On penetrating the first wall of the alveolus bone, the dentist feels a drop in the resistance. Now, the dentist removes the tap 11 from the alveolus bone, without risking penetrating a second wall of the alveolus bone with the tap 11.

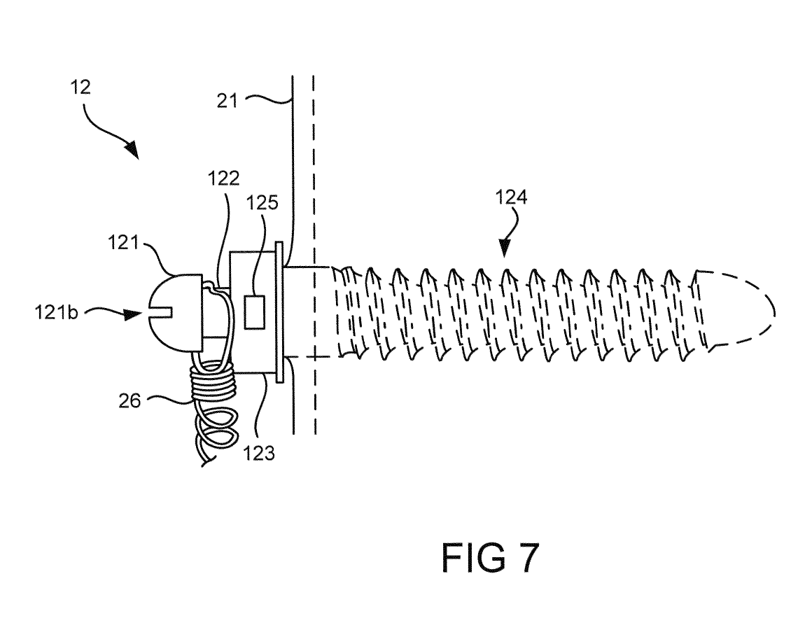

Referring to FIG. 7, the dentist uses the tool 13 to drive the screw 12 by the head 121, 121b or 121c, thus driving the body 124 of the screw 12 into the alveolus bone through the hole made with the blade 1243 and the thread 1241 of the screw 12. While driving the body 124 of the screw 12 into the marrow of the alveolus bone, the dentist encounters resistance. On reaching the second wall of the alveolus bone, the dentist feels growth in the resistance. Now, the dentist stops the screw 12. It is practically impossible for the dentist to penetrate the second wall of the alveolus bone with the rounded tip 1243 of the body 124 of the screw 12.

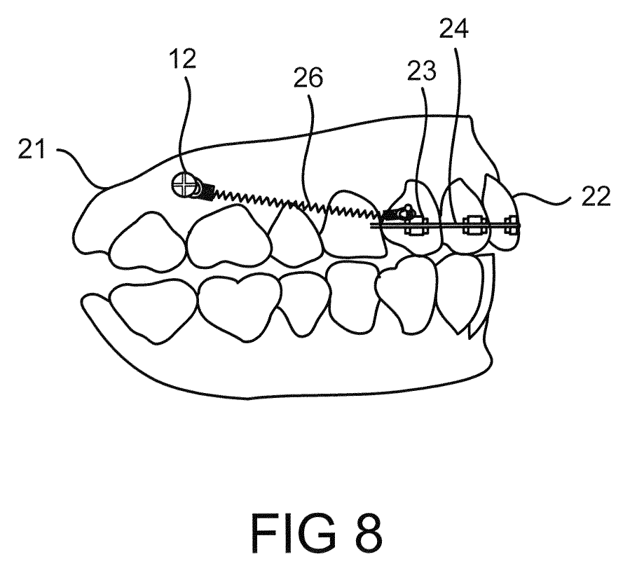

Referring to FIG. 8, a first wire 24 is provided. The first wire 24 is square in a cross-sectional view so that it can be used as a twist wire for exerting a torque. Moreover, the first wire 24 is elastic so that it can be used as a tensile wire for exerting a tensile force. Furthermore, the first wire 24 is made of appropriate rigidity so that it can be bent to obtain a desired direction of a tensile force.

In an orthodontic operation, the dentist attaches several orthodontic elements 23 to a patient's teeth 22 and connects the first wire 24 to the orthodontic elements 23, thus connecting the orthodontic elements 23 to one another. Then, the dentist ties an end of a spring 26 to one of the orthodontic elements 23 and another end of the spring 26 to the neck 122 of the screw 12, thus pulling the teeth 22 towards the screw 12.

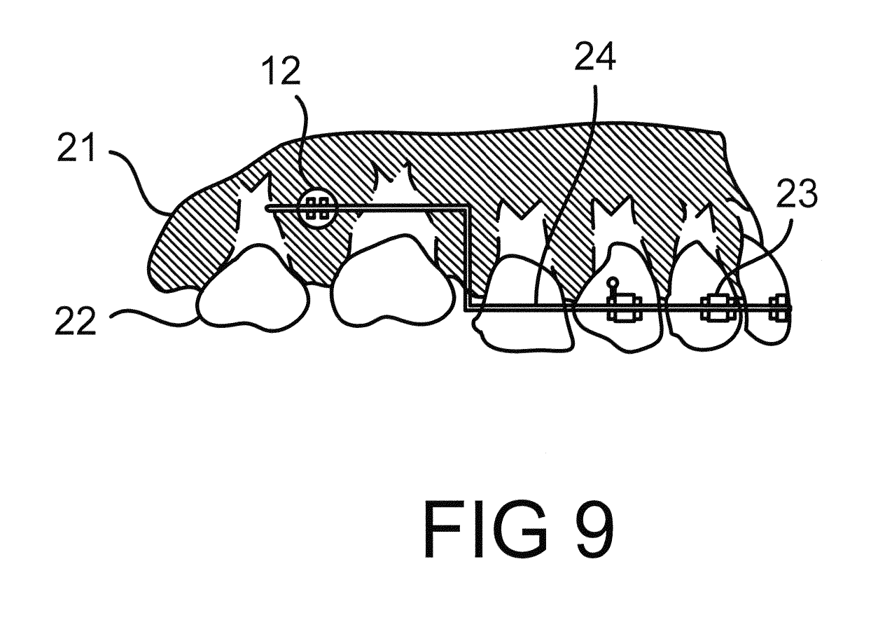

Referring to FIG. 9, in another orthodontic operation, the dentist attaches the orthodontic elements 23 to the teeth 22. Then, the dentist ties an end of the first wire 24 to the orthodontic elements 23 and another end of the first wire 24 to a selected one of the blocks 121b. The more the blocks 121b are, the easier a desired direction of the first wire 24 can be reached. The dentist pulls and bends the first wire 24 before tying it, thus providing a tensile force in a desired direction. Hence, the dentist pulls the teeth 22 towards the screw 12 without having to use any spring.

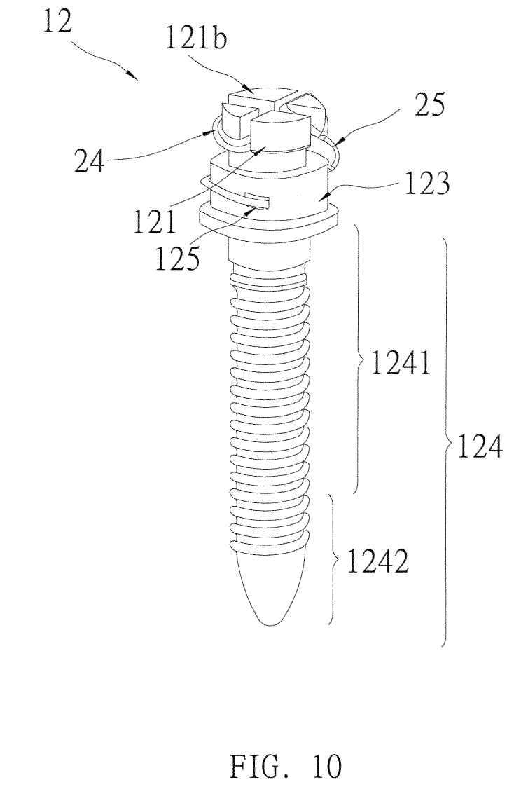

Referring to FIG. 10, the first wire 24 is tied to the head 121 of the screw 12. There is provided a second wire 25 that is rectangular in a cross-sectional view so that it can be used as a twist wire to provide a torque. An end of the second wire 25 is connected to the orthodontic elements 23. The second wire 25 is twisted. Another end of the second wire 25 is driven through the rectangular aperture 125 of the screw 12 and tied to a selected one of the blocks 121b. Thus, a torque is exerted on the teeth 22 with the second wire 25.

The orthodontic system of the present invention exhibits several advantages. Firstly, there is practically no risk of the necrosis of the gingival tissue. This is because the dentist manually drives the tap 11 into the alveolus bone through the gingival tissue with the tool 13 and can stop the tap 11 before shredding any portion of the gingival tissue.

Secondly, there is no risk of breaching the threaded body 71 because the tap 11 is used to make the hole in the first wall of the alveolus bone, and the screw 12 is driven into the marrow of the alveolus bone and stopped on reaching the second wall of the alveolus bone.

Thirdly, appropriate depth in the alveolus bone reached with the screw 12 is guaranteed because the screw 12 is stopped on the moment when the rounded tip 1243 of the screw 12 is abutted against the second wall of the alveolus bone. The support of the screw 12 by the first and second walls of the alveolus bone is more reliable than the support of a screw by only the first wall and marrow of the alveolus bone. At the same time, there is practically impossible to penetrate the second wall of the alveolus bone with the rounded tip 1243 of the screw 12.

Fourthly, a torque can be exerted on the teeth 22 using the second wire 25 together with the first wire 24 and the screw 12.

The present invention has been described via the detailed illustration of the embodiments. Those skilled in the art can derive variations from the embodiments without departing from the scope of the present invention. Therefore, the embodiments shall not limit the scope of the present invention defined in the claims.

1. An orthodontic system comprising:
a tap for making a hole in an alveolus bone;
a screw for firm insertion in the alveolus bone through the hole made with the tap; and
a tool for driving the tap and screw.

2. The orthodontic system according to claim 1, wherein the tap and screw are both made of a titanic alloy.

3. The orthodontic system according to claim 1, wherein the tap is made of stainless steel while the screw is made of a titanic alloy.

4. The orthodontic system according to claim 1, wherein the tap and screw both comprise a body, a platform formed on the body, a head and a neck formed between the platform and the head.

5. The orthodontic system according to claim 4, wherein the head is in the form of a dome.

6. The orthodontic system according to claim 4, wherein the head is a circular disc with radial slits defined therein.

7. The orthodontic system according to claim 4, wherein the head is a hexagonal disc with blocks formed thereon.

8. The orthodontic system according to claim 4, wherein the body of the tap comprises a thread formed thereon and a blade formed at the tip.

9. The orthodontic system according to claim 4, wherein the body of the screw comprises a thread formed thereon and a rounded tip.

10. The orthodontic system according to claim 4, wherein the screw comprises a rectangular aperture defined in the platform for receiving a second wire.

11. An orthodontic screw comprising a body, a platform on the body, a head, a neck between the platform and the head and a rectangular aperture in the platform for receiving a second wire.

12. The orthodontic system according to claim 11, wherein the head is in the form of a dome.

13. The orthodontic system according to claim 11, wherein the head is a circular disc divided into blocks.

14. The orthodontic system according to claim 13, wherein the head is divided into blocks.

15. The orthodontic system according to claim 11, wherein the head is a hexagonal disc.

16. The orthodontic system according to claim 15, wherein the head is divided into blocks.

17. The orthodontic system according to claim 11, wherein the body comprises a thread formed thereon and a blade formed at the tip.

18. The orthodontic system according to claim 11, wherein the body comprises a thread formed thereon and a rounded tip.
